(19) United States
(12) Patent Application Publication
(10) Pub. No.: US 2024/0361479 A1
(43) Pub. Date: Oct. 31, 2024

(54) PORTABLE GAMMA RAY COMPUTED TOMOGRAPHY (CT)

(71) Applicant: The Aerospace Corporation, El Segundo, CA (US)

(72) Inventors: Shant KENDERIAN, Pasadena, CA (US); Joseph Tobias CASE, Hawthorne, CA (US)

(73) Assignee: The Aerospace Corporation, El Segundo, CA (US)

(21) Appl. No.: 18/308,132

(22) Filed: Apr. 27, 2023

(51) Int. Cl. G01T 1/29; G21F 5/04

(52) U.S. Cl. CPC G01T 1/2985; G01T 1/2992; G21F 5/04

(57) ABSTRACT

A portable gamma ray computed topography (CT) device configured to capture images includes a projector, a collimator, and a detector. The projector includes an isotope encapsulated within a depleted uranium, and the collimator is affixed to the projector eliminating use of a guide tube. The apparatus also includes a crank cable affixed to the isotope, and is configured to extend the isotope out of projector and into the collimator. The apparatus further includes a detector configured to capture multiple shots on order of hundreds of shots to create a three-dimensional (3D) reconstruction from infield gamma ray images.

### FIELD

The present invention relates to imaging, and more particularly, to a portable gamma ray computed tomography (CT) that utilizes a custom gamma ray projector and algebraic reconstruction techniques (ART).

### BACKGROUND

Computed Tomography (CT) is typically performed using an X-ray source in an enclosed booth where a small part is rotated by a mechanical stage and thousands of images are taken that are subsequently reconstructed into a three dimensional (3D) image using conventional CT algorithms. This 3D image can be sliced and diced to view the inner details of an object. On very rare cases, the X-ray source was replaced with a gamma ray isotope for the production of a CT image. Although inferior in image sharpness compared to X-ray, gamma ray radiography has higher photon energy, which is necessary for dense or thicker materials under inspection.

Most objects in the field tend to be large, and as such, they cannot be removed to a cabinet to be inspected. Therefore, cabinet inspection and rotational symmetry are not practical. Furthermore, regions of interest on these structures have limited access and it is only feasible to capture a limited number of shots that do not have the circular symmetry required for conventional CT reconstruction techniques. With conventional techniques, small or low-density structures may be inspected by portable x-ray CT, which provides the inspection capability required to form high-resolution volume images.

Large or heavy structures require gamma ray's higher photon energy than that offered by x-ray. Therefore, portable open-configuration gamma ray CT is desired. However, gamma ray inspection utilizes an isotope 150 that cannot be shut off as opposed to an x-ray generator that has a power switch. Isotopes 150 are contained in a projector. For portable CT, nontrivial modifications must be made to the projector to allow reduced wear on isotope 150, maneuverability for the collection of CT shots, and increased safety for the operator.

FIG. 1 is related art illustrating a gamma ray projector 100. The gamma ray projector 100 has a drive cable 105 and a guide tube 115, both of which are attached to shielding material 110, where depleted uranium is commonly used. At the far end of guide tube 115 is a collimator 120. With gamma ray projector 100, drive cable 105 drives a cable (or flexible wire), which holds an encapsulated radioactive isotope (hereinafter “isotope”) 150 within the shielding material 110, through guide tube 115 and into collimator 120.

Simply put, gamma ray projector 100 contains an isotope 150 connected to the end of the flexible cable, called “Pigtail”.

Isotope 150 is encapsulated to prevent the loss of radioactive material. Inside the gamma ray projector 100, isotope 150 resides in an area which is heavily shielded with depleted uranium 110. Further, the gamma ray projector 100 is equipped with a port that connects the Pigtail to a drive cable (long crank cable) 105. On the opposite end, the gamma ray projector 100 is equipped with a port that connects to a guide tube 115. On other end of guide tube 115, a collimator 120 is attached thereto.

Collimator 120 functions as the aperture from which radiation is emitted in a specific direction. Collimator 120 is placed near the part being radiographed. Once the drive (crank) cable and guide tube 115 are locked (securely) in place, the radiographer cranks out isotope 150 until isotope 150 stops at collimator 120. The object under test would be placed between collimator 120 and gamma ray detector (e.g.; film, digital detector, plate) 160. The radiographer then walks away for the duration of the exposure. Before that, however, the radiographer is subjected to radiation from isotope 150 until isotope 150 is within collimator 120. Collimator 120, for purposes of explanation, contains radiation exposure to isotope 150 from all sides except for the aperture on the underside of collimator 120. See FIG. 1, for example. This is where the gamma ray image is typically taken.

The gamma ray projector 100 however is suited for individual shots (or images) of the specimen under test and not multiple shots on the order of hundreds of shots to create a three-dimensional reconstruction from the in field gamma ray images. Further, with the gamma ray projector 100, the radiographer is exposed to isotope 150 while traveling through guide tube 115 until isotope 150 is inside of collimator 120.

In order to overcome these issues from a conventional projector, an improved gamma ray projector for portable CT may be beneficial.

### SUMMARY

Certain embodiments of the present invention may provide solutions to the problems and needs in the art that have not yet been fully identified, appreciated, or solved by current CT technologies. For example, some embodiments of the present invention pertain to a gamma ray portable CT.

In one embodiment, an apparatus configured to capture a plurality of images includes a projector and a collimator. The projector includes an isotope encapsulated within depleted uranium, and the collimator is affixed to the projector eliminating use of a guide tube. The apparatus also includes a crank cable affixed to the isotope, and is configured to extend the isotope out of projector and into the collimator. The apparatus further includes a detector is configured to capture multiple shots on order of hundreds of shots to create a 3D reconstruction from infield gamma ray images.

In some additional embodiments, a remote electronic control of projector device parameters includes source deployment, shutter opening, radiation warning lights, and projector movement.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is related art illustrating a gamma ray projector.

FIG. 2 is a diagram illustrating a portal gamma ray projector, according to an embodiment of the present invention.

FIG. 3 is a diagram illustrating a collimator and aperture inserts, according to an embodiment of the present invention.

### DETAILED DESCRIPTION OF THE EMBODIMENTS

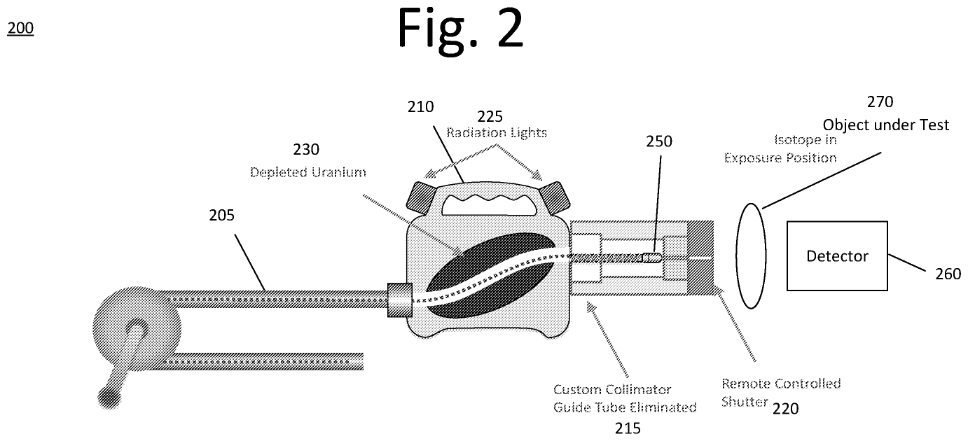

Some embodiments generally pertain to a portal gamma ray CT device that can be used within the field. In the field, best-of-breed inspection techniques, such as CT, may be required for large structures or regions of interest on large structures. The large structure may be, but is not limited to, a bridge, dam, building, or hull. Portable gamma ray CT device may be useful to diagnose the structure including, but not limited to, fatigue cracks in aging infrastructure or quantify the volumetric extent of visible damage. The portable gamma ray CT device includes a gamma ray projector in conjunction with a gamma ray detector that collects the necessary number of shots for reconstruction. The projector however is modified to reduce wear and tear on internal components including the encapsulated isotope as well as increase protection for the technician from radiation exposure. See, for example, FIG. 2, which is a diagram illustrating projector 200 for portable gamma ray CT, according to an embodiment of the present invention. In this embodiment, gamma ray projector 200 includes a drive cable 205, a projector body 210 and a collimator 215 affixed to projector body 210.

### Collimator

One of the main challenges in using gamma ray is that the radiation source (i.e., isotope 250) size tends to be on the order of a few millimeters causing decreased sharpness in the image compared to a microfocus x-ray source. The radiation energy produced from isotope 250, however, is higher than the energy produced from an x-ray source. In some embodiments, collimator 215 is used with a gamma ray source to limit radiation emission only toward the object. An object under test 270 is placed between collimator 215 and a gamma ray detector 260. Gamma ray detector 260 may capture multiple shots on order of hundreds of shots to create a 3D reconstruction from in field gamma ray images.

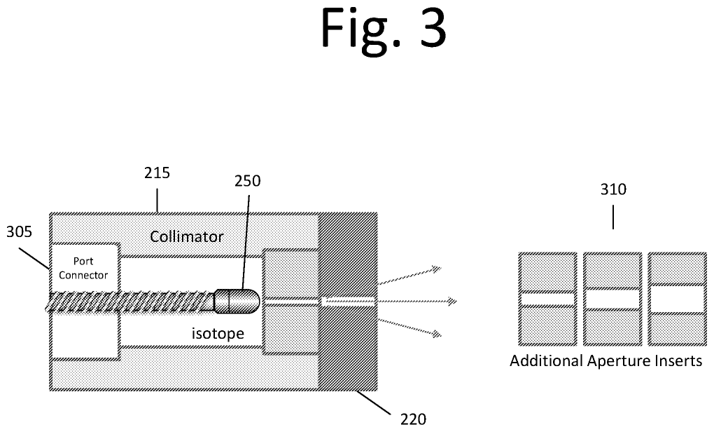

In these embodiments, collimator 215 is equipped with (aperture) inserts 310 that limit the encapsulated isotope window to smaller openings; such as 1 mm, 0.5 mm and 0.25 mm, effectively reducing the source size and producing sharper images to be used in the CT reconstructed 3D image. See, for example, FIG. 3, which is a diagram illustrating a collimator 215 and aperture inserts 310. In FIG. 3, isotope 250 extends out of port connector 305 (that connects to the projector's port), passes through the body of collimator 215, and stops behind the aperture insert 310.

The size of aperture inserts 310 is directly proportional to the un-sharpness of a radiographic image and the un-sharpness in the reconstructed volumetric image. However, a reduced aperture also increases the required exposure time to form an image, where the exposure time is the time that the part under test 270 and the gamma ray detector 260 are exposed to radiation. The size of aperture inserts 310 must carefully, simultaneously optimize the sharpness of an image and exposure time. To summarize, aperture inserts 310 are configured to increase sharpness in the acquired images and reconstructed volumetric image.

Returning to FIG. 2, in some embodiments, collimator 215 is equipped with an electronically (or remote) controlled shutter 220 operated remotely. By using electronically controlled shutter 220, successive exposures are enabled without the need to retract isotope 250 back into projector body 210 after each exposure. This allows for the operator to approach the inspection area without retracting isotope 250 into the center of the projector shielded with depleted Uranium 230, thus preventing wear and tear on isotope 250. In some embodiments, shutter 220 would be mechanical to open and close and may block aperture insert 310. Also, in some embodiments, shutter 220 may be a small plate that rotates in, or slides in, to block aperture insert 310. For illustrative purposes, shutter (consisting of a dense metal) 220 essentially blocks a small hole from where the arrows are coming out of in FIG. 3. This shutter 220 could be 3 or more half value layers thick to stop radiation.

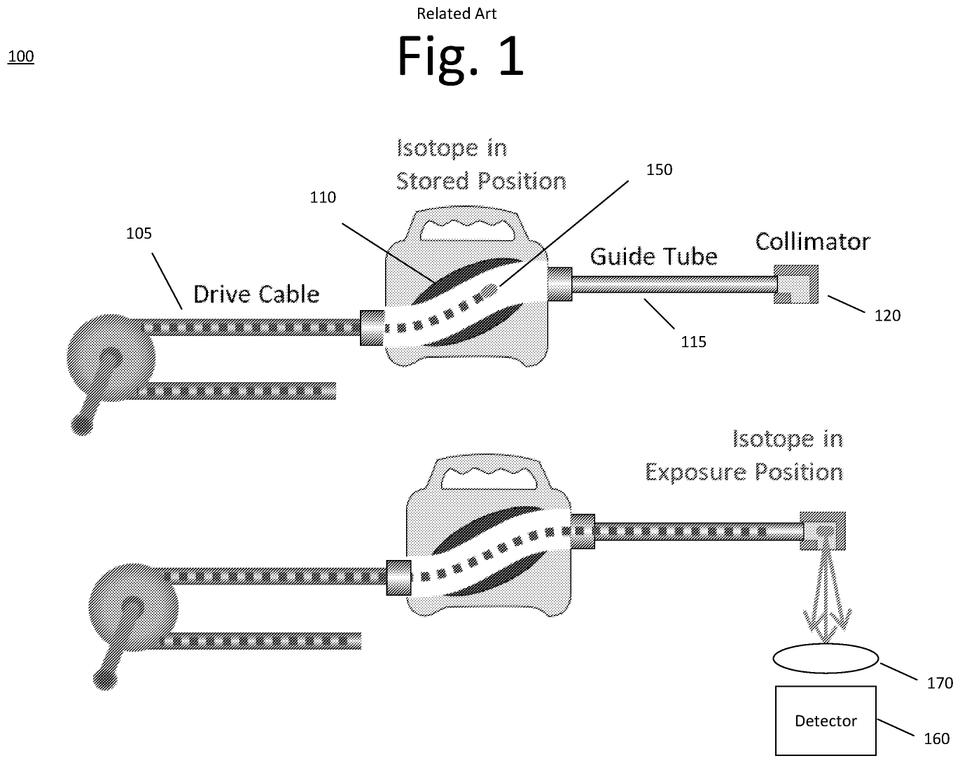

As shown in FIG. 2, collimator 215 is constructed such that it is connected directly to a port on projector body 210. This eliminates the need to use the guide tube (see FIG. 1). The elimination of the guide tube reduces the travel path of isotope 250 to one or two inches inside collimator 215 rather than feet through the unshielded guide tube. This eliminates wear on isotope 250 and prevents exposure to the radiographer.

Furthermore, by eliminating the guide tube (as shown in FIG. 1), other issues that would otherwise crop up with the guide tube are eliminated. One example of an issue would be, if the pigtail with isotope 250 becomes dislodged in the guide tube, the radiographer would have to risk exposure and approach guide tube (and isotope 250) to retrieve it so it can be fixed later.

Collimator 215 may carry a number of half value layers (HVL) or any value that provide sufficiently safe operating conditions, depending on the design. With the embodiments described herein, the radiation directed toward the operator is significantly reduced to pose little or no risk to the operator.

### Guide Tube

Although a guide tube is not explicitly shown in FIGS. 2 and 3, in some embodiments, a short guide tube may be used. This short guide tube would be connected between the projector and the collimator similar to that shown in FIG. 1, but with a much shorter guide tube. This shorter guide tube may reduce wear on isotope 250 and reduce radiation exposure to the radiographer.

### Projector

Within projector body 210, isotope 250 is shielded inside a depleted uranium 230. When isotope 250 is deployed into collimator 215 design discussed above, some backscatter from isotope 250 may escape toward the radiographer. In this modified design, additional shielding is added to contain the escaped radiation.

Considering the option of leaving isotope 250 in the deployed position rather than crank it in and out of projector body 210 for each shot, a visual warning (e.g., red light) 225 is added to inform the radiographer that isotope 250 is in the deployed position.

Furthermore, if the crank action is automated by computer control, an electric signal will be provided to the user in addition to the visual warning mentioned above.

### Crank Cable

Repeatability and consistency of exposures is important in the tomographic reconstruction of radiographs. Rather than manually cranking isotope 250 in and out of projector body 210, an electronic device may be employed to deploy isotope 250 and precisely control the exposure time. See, for example, FIGS. 2 and 3.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus configured to capture images, comprising:
a projector comprising an isotope encapsulated within a depleted uranium;
a collimator affixed to the projector eliminating use of a guide tube;
a crank cable affixed to the isotope and is configured to extend the isotope out of projector and into the collimator; and
a detector is configured to capture multiple shots on order of hundreds of shots to create a three-dimensional (3D) reconstruction from infield gamma ray images.

2. The apparatus of claim 1, wherein the collimator comprises a projector port affixed to the projector, facilitating insertion of the isotope into, and retraction of the isotope out of, the collimator.

3. The apparatus of claim 2, wherein the isotope extends out of the projector port and is placed in front of the aperture insert.

4. The apparatus of claim 1, wherein the collimator comprises an aperture insert is configured to optimize sharpness of the images and exposure time of the images.

5. The apparatus of claim 1, wherein the collimator comprises an electronically controlled shutter configured to open and close for each exposure, where an exposure is a length of time where the part under inspection and the detector are exposed to radiation.

6. The apparatus of claim 5, wherein the electronically controlled shutter is configured to facilitate successive exposures without retracting the isotope back into the projector after each exposure.

7. The apparatus of claim 5, wherein the shutter is configured to block an aperture insert during each exposure.

8. The apparatus of claim 7, wherein the shutter is a small plate that rotates in, or slides in, to block the aperture insert.

9. An apparatus configured to capture images, comprising:
a projector comprising an isotope encapsulated within a depleted uranium;
a collimator affixed to the projector eliminating use of a guide tube, wherein the collimator comprises a projector port affixed to the projector, facilitating insertion of the isotope into, and retraction of the isotope out of, the collimator;
a crank cable affixed to the isotope and is configured to extend the isotope out of projector and into the collimator; and
a detector is configured to capture multiple shots on order of hundreds of shots to create a three-dimensional (3D) reconstruction from infield gamma ray images.

10. The apparatus of claim 9, wherein the isotope extends out of the projector port and is placed in front of the aperture insert.

11. The apparatus of claim 9, wherein the collimator comprises an aperture insert is configured to optimize sharpness of the images and exposure time of the images.

12. The apparatus of claim 9, wherein the collimator comprises an electronically controlled shutter configured to open and close for each exposure, where an exposure is a length of time where the part under inspection and the detector are exposed to radiation.

13. The apparatus of claim 12, wherein the electronically controlled shutter is configured to facilitate successive exposures without retracting the isotope back into the projector after each exposure.

14. The apparatus of claim 12, wherein the shutter is configured to block an aperture insert during each exposure.

15. The apparatus of claim 14, wherein the shutter is a small plate that rotates in, or slides in, to block the aperture insert.

16. A portable gamma ray computed tomography (CT) system configured to capture images, comprising:
a projector comprising an isotope encapsulated within a depleted uranium;
a collimator affixed to the projector eliminating use of a guide tube, wherein
the collimator comprises
a projector port affixed to the projector, facilitating insertion of the isotope into, and retraction of the isotope out of, the collimator,
the isotope extending out of the projector port and being placed in front of the aperture insert, and;
a crank cable affixed to the isotope and is configured to extend the isotope out of projector and into the collimator; and
a detector is configured to capture multiple shots on order of hundreds of shots to create a three-dimensional (3D) reconstruction from infield gamma ray images.

17. The apparatus of claim 16, wherein the collimator comprises an aperture insert is configured to optimize sharpness of the images and exposure time of the images.

18. The apparatus of claim 16, wherein the collimator comprises an electronically controlled shutter configured to open and close for each exposure, where an exposure is a length of time where the part under inspection and the detector are exposed to radiation.

19. The apparatus of claim 18, wherein the electronically controlled shutter is configured to facilitate successive exposures without retracting the isotope back into the projector after each exposure.

20. The apparatus of claim 18, wherein the shutter is configured to block an aperture insert during each exposure.

21. The apparatus of claim 20, wherein the shutter is a small plate that rotates in, or slides in, to block the aperture insert.
